(19) United States
(12) Patent Application Publication
(10) Pub. No.: US 2024/0377023 A1
(43) Pub. Date: Nov. 14, 2024

(54) HOLDING APPARATUS FOR A LINE-GUIDING DEVICE, IN PARTICULAR A CABLE CARRIER, AND ARRANGEMENT THEREWITH

(71) Applicant: IGUS GMBH, Koeln (DE)

(72) Inventors: Karl Oskar LAPIERE, Troisdorf (DE); Theo DIEHL, Reinheim-Ueberau (DE)

(21) Appl. No.: 18/684,251

(22) PCT Filed: Aug. 3, 2022
(86) PCT No.: PCT/EP2022/071861

§ 371 Date: Feb. 16, 2024

(30) Foreign Application Priority Data
Aug. 20, 2021 (DE) 20 2021 104 498.5

(51) Int. Cl. F16M 13/02

(52) U.S. Cl. CPC F16M 13/022

(57) ABSTRACT

A holding apparatus for a line-guiding device, in particular for a cable carrier, which extends between two connection points which are movable relative to one another, and comprises a strand which can be connected to one of the connection points and a strand which can be connected to the other connection point, and a deflection bend connecting the strands. The holding device and the switching device are arranged on a rocker element which is mounted on the holder so as to be rotatable about an axis of rotation and which has a first leg and a second leg, wherein the second leg is arranged offset with respect to the first leg in the longitudinal direction of the axis of rotation.

### FIELD

The invention relates to a holding apparatus for a line guide device. This line guide device extends between two connection points mobile relative to one another and comprises one run connectable to one of the connection points and one run connectable to the other connection point and a deflection arc connecting the runs. The holding apparatus has at least one holding device, which is displaceable between a first position and a second position, and a switching device, which can be used to bring this displacement about.

The term “displace” here means, in particular, movement from one location to another location, the type of movement not being critical. The displacement may, for example, take the form of swiveling or rotational motion, translational motion or indeed combined translational-rotational motion.

The holding apparatus additionally has a holder for the holding device.

The line guide device may take the form of an energy guide chain. The line guide device to be held by such a holding apparatus may, for example, more precisely be an energy guide chain for receiving cables, hoses or flexible pipes, in which adjacent links are joined together in articulated manner, band chains, in which links are connected together by a flexible band, or other apparatuses for receiving lines and which are bendable in at least one plane.

The invention also relates to an arrangement having such a holding apparatus and a line guide device.

### BACKGROUND

Such holding apparatus and arrangements are, for example, already known from DE 23 62 463 A1. They are used for relatively long travel paths for example in the horizontal direction.

One disadvantage of known holding apparatus and arrangements is that they can be expensive to manufacture and susceptible to failure and may stress the line guide device to a greater extent than might be desirable.

### SUMMARY

The object of the invention is therefore to provide such a holding apparatus and arrangement which are improved at least with regard to one of the stated disadvantages.

In the case of the holding apparatus according to the invention, the holding device and the switching device are arranged on a, preferably on precisely one, rocker element mounted on the holder for rotation about an axis of rotation. The rocker element has a first leg and a second leg. The second leg is arranged offset relative to the first leg in the longitudinal direction of the axis of rotation.

Such a rocker element puts one of the requirements in place for a simply manufacturable, reliable holding apparatus.

Due to their offset arrangement, the second leg and the first leg are preferably not arranged at the same level on the axis of rotation. The second leg preferably at least also extends over a different portion of the axis of rotation from the first leg. The first and second legs preferably do not extend over a common portion of the axis of rotation or this common portion is shorter than half or ¼ or 1/10 of the longest extent of the first and/or second leg in the direction of the axis of rotation. With the exception of any region in which the first leg and the second leg extend over a common portion of the axis of rotation, each leg preferably leaves a space in the region of the axis of rotation over which the respective other leg extends. In the embodiment in which the first and second legs do not extend over a common portion of the axis of rotation, they may adjoin one another or be spaced from one another in the direction of the axis of rotation. In the case of quick-running line guide devices, the spacing may in particular ensure timely displacement of the holding device from its second position into its first position and thus trouble-free passage of the deflection arc. The spacing is preferably less than ten times the extent of the first leg in the direction of the longitudinal axis.

The first leg may also be designated “switching leg”. The second leg may preferably also be designated “holding leg”.

The holding device preferably comprises or is formed by the second leg, or the second leg forms the holding device.

The switching device preferably comprises or is formed by the first leg.

The line guide device or the deflection arc of the line guide device is preferably displaceable.

The holding apparatus is preferably configured to hold one run of the line guide device temporarily in such a way that no relative motion is possible between this run and the holding apparatus.

Alternatively, the holding apparatus may be configured to hold one run of the line guide device temporarily in such a way that the latter moves on or along the holding apparatus. In this alternative in particular, the holding apparatus may also be designated “guide device”.

The holding device is preferably displaceable between the first position and the second position by rotation about the axis of rotation, preferably by at least 45° and in particular by at least 80° and in particular by at least 90° and preferably by less than 180° and in particular by less than 100°.

The holding device is preferably rotatable by approximately 90° between the first position and the second position.

The term “rocker element” here denotes in particular any element which is set up to exert alternating rotational movements, preferably identical in magnitude, in opposing directions of rotation.

The rocker element is preferably mounted so as to be rotatable by at least 45° and in particular by at least 80° and in particular by at least 90° and preferably by less than 180º and in particular by less than 100°. The rocker element is preferably mounted so as to be rotatable by approximately 90°.

The rotation of the rocker element displacing the holding device from its first position into the second position is preferably in the opposite direction from and identical in magnitude to the rotation of the rocker element displacing the holding device from its second position into the first position.

The holding element is preferably displaceable from the first position into the second position through contact of the rocker element with the line guide device. The holding element is preferably displaceable back from the second position into the first position using the weight force of the rocker element.

The switching device is actuatable by the line guide device, preferably the deflection arc of the line guide device. The holding device is preferably displaceable from one of its positions, preferably the first position, into the respective other position, preferably the second position, through actuation of the switching device, preferably by the line guide device.

The second position of the holding device is preferably a holding and/or supporting position, in which one run of the line guide device is respectively holdable or supportable from below by way of the holding device. The holding device may in particular support the upper run of the line guide device. The deflection arc of the line guide device preferably cannot be passed through the holding apparatus for as long as the holding device is in the second position. The first position of the holding device is preferably a retracted position in which a run of the line guide device is not holdable by way of the holding device or the upper run is not supportable from below. The deflection arc of the line guide device can preferably be passed through the holding apparatus for as long as the holding device is in the first position. In the first position, the deflection arc of the line guide device can preferably pass the holding device contactlessly.

The legs of the rocker element are preferably bent relative to one another, in particular by approximately 90°.

The legs are preferably non-displaceable relative to one another or the rocker element is configured such that the legs lie or are bent at a fixed, unmodifiable angle relative to one another. The rocker element is preferably of a one-piece embodiment.

The rocker element is preferably embodied or configured in torsion-resistant manner, at least in terms of the relative position of the legs, in particular in relation to the axis of rotation.

The holding device preferably comprises a, preferably planar, holding face of the second leg for contact with the line guide device.

The holding face of the second leg may run parallel to the second leg and/or be formed by the second leg. The holding face of the second leg preferably takes the form of a static friction face. The holding face of the second leg or the holding device preferably has no rollers. The holding face of the second leg preferably takes the form of an upper run contact face and more preferably of an upper run bearing face. The planar holding face of the second leg may preferably introduce holding forces into the line guide device in planar manner. The planar holding face of the second leg may more preferably, over its surface, absorb the weight force of the upper run or fractions of the weight force of the upper run. Punctiform or linear loading of the line guide device with holding forces may preferably be avoided.

Each run of the line guide device preferably has an at least roughly rectangular cross-section with a height and a width. The width is preferably greater than the height. The line guide device preferably has an outer face. The term “outer face” is used here in particular to mean the face of the two runs of the line guide device which faces away from the respective other run as well as the face connecting these faces in the region of the deflection arc. The line guide device preferably has two opposing side faces, which more preferably in each case adjoin the outer face. Each side face preferably extends in a single plane even in the region of the deflection arc. The line guide device preferably has an inner face. This term is used here in particular to mean the opposite face of a run or of the deflection arc from the associated outer face. The line guide device preferably in each case forms an edge between each side face and the outer face.

The holding device is preferably displaceable into its second position, by the second leg of the rocker element, or more precisely the holding face of the holding device, being applied against the inner face of the line guide device in the region of one run and in this way holding this run.

The switching device preferably comprises a switching edge or a switching face for contacting the line guide device, wherein this switching edge or switching face is provided in particular on the first leg.

The switching edge or switching face may be configured to contact one, preferably precisely one, edge of the line guide device, in particular between a side face and an outer face of the line guide device, and in particular in the region of the deflection arc.

The switching edge or switching face may alternatively or additionally be configured to contact the outer face of the line guide device in particular in the region of the deflection arc.

The switching edge or switching face may alternatively or additionally be configured to contact one, preferably precisely one, side face of the line guide device in particular in the region of the deflection arc.

The switching edge or switching face preferably does not interact exclusively with the side face of the line guide device.

The first leg and second leg preferably have a free end.

The switching edge or switching face is preferably arranged at the free end of the first leg or formed thereby. The switching edge or switching face preferably extends obliquely to the axis of rotation and/or in curved manner, preferably such that the distance thereof from the axis of rotation increases in the direction pointing along the axis of rotation and away from the holding device.

This preferably ensures that the switching edge or switching face projects, in the direction corresponding to the direction of movement of the line guide device approaching the holding device, increasingly into the travel path of the line guide device.

The switching face may be twisted on itself, preferably by approximately 90° or approximately around 45°. In this way, the rotational position of the region of the switching face in contact with an edge and/or the outer face and/or a side face of the line guide device relative to the line guide device can be maintained during rotation of the rocker element which displaces the holding device from the first position thereof into the second position. The switching face is preferably twisted on itself in such a way that at least in part compensates rotation of the rocker element, which is brought about by the switching element interacting with the line guide device, in the contact region between an edge and/or the outer face and/or a side face of the line guide device and the switching face.

The rocker element is preferably rotationally lockable. To bring about rotational locking, the switching device may also be embodied as a rotational locking device, such that it not only brings about displacement of the holding device between the first position and the second position but also maintenance of at least one of these positions, in particular the second position.

Alternatively or additionally, the holding apparatus may have a rotational locking device for bringing about rotational locking which may differ from the switching device or which may at least have regions which differ from the switching device.

The rocker element is preferably rotationally lockable using a rotational locking device, which preferably differs from the switching device at least in places.

The rotational locking device can preferably be enabled and disabled, preferably by the line guide device.

The rocker element is preferably embodied such that, after a rotation of the rocker element displacing the holding device from its first position into the second position, the holding device remains in its second position for as long as the rotational locking device is enabled, preferably by contact with the line guide device.

The rocker element is preferably embodied such that, on disabling the rotational locking device, the holding device can be displaced back in its first position, preferably by corresponding rotation of the rocker element.

The rocker element is preferably embodied such that the holding device is located in its first position whenever the rotational locking device is disabled.

In any event, forces act between the holding device and the rotational locking device when the holding device is in its second position and holds a line guide device. These forces preferably act in the rocker element. These forces preferably exclusively or predominantly bring about torsional stress of the rocker element. The rocker element is preferably configured to absorb, by way of torsional stress, forces brought about by holding a line guide device. This puts one of the conditions in place for these forces, as preferred, to be absorbed by the rocker element with lower material and manufacturing costs for the rocker element than would be the case if these forces were exclusively or predominantly to bring about bending stress of the rocker element.

The rotational locking device preferably serves to prevent rotation of the rocker element when the line guide device is held by the holding device, for as long as the deflection arc is not being passed through. The rotational locking device preferably absorbs a reactive force to the holding and/or supporting force exerted by the holding apparatus on the line guide device. For example, the rotational locking device absorbs the weight force of the upper run.

The rotational locking device preferably comprises a locking face. The locking face preferably serves in contacting a side face of the line guide device and more preferably in introducing locking pressure forces into this side face. The locking face is preferably arranged on the first leg. The locking face may be part of the switching face. It is preferably at least in part different from the switching face. Locking forces in the form of pressure forces are preferably introducible into a side face of the line guide device by way of the locking face. The first leg preferably has a side face preferably defined by its free end. This side face forms an angle of approximately 90° with the holding face of the second leg in the direction of view of the axis of rotation. The locking face preferably comprises or is formed by this side face. This side face may adjoin the switching edge or switching face of the first leg and/or it may merge into it.

The holding apparatus preferably has a side guide for the line guide device. The side guide preferably interacts with side faces of the line guide device. The side guide may be formed as a guide rail formed over the entire longitudinal extent of the line guide device. However, the side guide is preferably interrupted over the longitudinal extent of the line guide device. The side guide preferably comprises a counter-holder for introducing locking pressure reactive forces into a side face of the line guide device. The counter-holder is preferably configured such that it can introduce locking pressure reactive forces into a side face of the line guide device which is opposite the side face into which the locking pressure forces are introducible by way of the rotational locking device. The counter-holder preferably prevents lateral displacement of the region of the line guide device on which the locking pressure forces are exerted. The counter-holder is preferably of non-displaceable configuration for holding the holding apparatus.

In the viewing direction parallel to the axis of rotation, the second leg may form an “L” shape together with the first leg.

The length of the greatest extent of the first leg in a direction perpendicular to the axis of rotation may correspond at least substantially to the length of the greatest extent of the second leg in a direction perpendicular to the axis of rotation. The difference in length between the greatest extent of the first leg in a direction perpendicular to the axis of rotation and the length of the greatest extent of the second leg in a direction perpendicular to the axis of rotation is preferably less than half and in particular less than a quarter of the length of the greatest extent of the second leg in a direction perpendicular to the axis of rotation.

The rocker element preferably comprises a projection arranged on the first leg and preferably bent relative thereto. This projection preferably extends at least substantially parallel to the second leg at a distance therefrom. The projection preferably has a face facing toward the second leg. The switching edge or switching face and/or the locking face may adjoin this face of the projection and/or merge into this face. The projection is preferably arranged at the free end of the first leg. The projection preferably projects from a region of the first leg which is furthest away from the second leg in the direction of the axis of rotation and which more preferably is at the greatest distance from the axis of rotation.

The length of the projection between its free end and the opposite end thereof may correspond at least substantially to the length of the greatest extent of the second leg in a direction perpendicular to the axis of rotation. The difference in length of the projection between its free end and the opposite end thereof and the length of the greatest extent of the second leg in a direction perpendicular to the axis of rotation is preferably less than half and in particular less than a quarter of the length of the greatest extent of the second leg in a direction perpendicular to the axis of rotation.

In a viewing direction parallel to the axis of rotation, the rocker element may preferably form a “C” shape, with legs that are particularly preferably at least substantially of equal length in this direction of view, said legs more preferably extending at least substantially parallel to one another. The second leg and the projection may preferably form the legs of this “C” shape and the first leg may form the connecting region of the “C” shape.

The holding apparatus preferably comprises at least one pivot bearing bringing about rotatable mounting of the rocker element relative to the holder and defining the axis of rotation. The pivot bearing preferably comprises a pivot bearing part arranged on the rocker element and a pivot bearing part interacting with this pivot bearing part and arranged on the holder. The pivot bearing part arranged on the holding may comprise a bolt, which may be screwed into the holder, and the pivot bearing part arranged on the rocker element may comprise a recess corresponding to the bolt, for example in the form of a drill hole. Two pivot bearings are preferably provided which comprise two pivot bearing parts spaced apart on the rocker element in the direction of the axis of rotation and more preferably two pivot bearing parts on the holder. One of the pivot bearing parts of the rocker element may be arranged on the first leg and the other of these pivot bearing parts may be arranged on the second leg. One of the pivot bearing parts of the rocker element is preferably arranged on the first leg and the second pivot bearing part of the rocker element on a bearing projection, which preferably projects from the second leg.

In one embodiment, the rocker element consists of the first leg, the second leg, the projection, the bearing projection and two pivot bearing parts.

The projection preferably extends obliquely relative to the axis of rotation.

In one preferred embodiment, the free end of the projection is further away from the holding device than its opposite end.

The holding apparatus preferably comprises an insertion device. This preferably has at least one insertion bevel. The insertion device preferably corrects any lateral malpositioning of the line guide device, to ensure trouble-free insertion of the line guide device into the holding apparatus. The insertion device may comprise the side guide.

In the case of a section plane extending perpendicular to the axis of rotation, the holder may preferably form a “Z”-shaped cross-section, preferably with a connecting region and two end regions projecting in each case perpendicularly and in different directions from opposite ends of this connecting region. At one of these end regions, at least one protrusion extending perpendicular to the axis of rotation may be provided, on which the pivot bearing or a pivot bearing part may be arranged. One of these end regions preferably has two protrusions, on each of which is arranged a pivot bearing part, the rocker element more preferably being arranged between these protrusions. At the other end region, fastening means may be provided for fastening the holder for example to a support, for instance an I beam. The fastening means may comprise holes for fastening screws.

The holder may provide a rotation stop for the rocker element. The rotation stop preferably limits rotation of the rocker element which displaces the holding device from its second position into the first position.

When viewed in the direction of the axis of rotation, the rocker element preferably has a region in which the first leg merges into the second leg. The axis of rotation may be arranged in this region. The axis of rotation may run through both legs. The axis of rotation preferably runs through just one leg, particularly preferably just through the first leg. This may result in particularly advantageous positioning of the rocker element relative to the line guide device, in particular when the holding device is in its first position and when the holding device is in an intermediate position between the first and second positions.

The arrangement according to the invention comprises at least one holding apparatus. Furthermore, the arrangement according to the invention comprises a line guide device which extends between two connection points mobile relative to one another and comprises one run connectable to one of the connection points and one run connectable to the other connection point and a deflection arc connecting the runs, and a longitudinal extent, an outer face, an inner face and two opposing side faces. The line guide device preferably takes the form of an energy guide chain. The axis of rotation about which the rocker element of the holding apparatus is mounted rotatably on the holder is arranged parallel to the longitudinal extent of the line guide device. The direction of the longitudinal extent of the line guide device preferably corresponds to the direction in which the mobile connection point of the line guide device is mobile.

The arrangement is preferably configured in such a way that the holding apparatus does not impair passage of the deflection arc when the line guide device is moved back and forth. The rocker element is preferably rotationally lockable.

In one preferred embodiment, when the line guide device approaches the holding apparatus the holding device initially occupies its first position through movement of the line guide device, in particular through movement of the mobile connection point.

The arrangement is preferably configured such that, when the line guide device approaches the holding apparatus, the holding device is located in its first position and the deflection arc firstly passes the second leg of the rocker element, preferably contactlessly, before reaching the first leg of the rocker element, and, through contact therewith prior to complete passage of the deflection arc through the holding apparatus, the rocker element effects a rotation displacing the holding device from its first into the second position. Preferably, as a result of this rotation the second leg positions itself against the inner surface of the line guide device in the region of one run and holds this run in this manner. The rocker element is preferably rotationally locked, preferably by the locking face of the rotational locking device positioning itself against a side face of the line guide device. This preferably brings about reliable holding of the line guide device.

In order also to allow passage of the deflection arc through the holding apparatus in the event of movement of the line guide device in the opposite direction, on this movement of the line guide device and as the deflection arc approaches this holding apparatus, the held run firstly moves away from the first leg, and thus preferably from the rotational locking device, preferably by merging into the deflection arc. Rotational locking is preferably disabled thereby. The rocker element therefore preferably effects a rotation displacing the holding device from its second position into the first position. This preferably takes place before the deflection arc reaches the second leg and more preferably using the weight force of the second leg and preferably of the projection.

In a preferred embodiment, the line guide device extends between a stationary connection point and a mobile connection point. The line guide device preferably comprises an upper run connectable to the stationary connection point and a lower run extending below the upper run and connectable to the mobile connection point. This allows the advantages of the invention to be particularly effectively achieved. Use of the holding apparatus preferably prevents sagging of the upper run, the upper run preferably thus being held up by the holding apparatus. The holding apparatus preferably guides the upper run and prevents it from turning over.

Alternatively, the line guide device may preferably comprise a lower run connectable to the stationary connection point and an upper run extending below the lower run and connectable to the mobile connection point.

In a further alternative, the line guide device may comprise a vertically extending first run connectable to the stationary connection point and a vertically extending second run connectable to the mobile connection point.

The arrangement preferably has a plurality of holding apparatus which are arranged distributed along the travel path of the line guide device, in particular in order to support the upper run at regular intervals.

In the embodiment in which the arrangement comprises a plurality of holding apparatus, the rocker elements of the holding apparatus are arranged on just one side of the line guide device. This allows the number of necessary rocker elements to be halved in comparison with an arrangement in which the rocker elements are arranged on both sides of the line guide device. It has been found that a bilateral arrangement of rocker elements, in particular in the embodiment in which the holding apparatus has a side guide for the line guide device which comprises a counter-holder, is not absolutely necessary.

The holding device is preferably displaceable by the switching device from the first position into the second position in particular through contact of the line guide device with the switching device and from the second position into the first position through weight force and/or spring force. The holding device may be displaceable from the second position into the first position using the weight force of the first leg. The holding device may be displaceable from the second position into the first position using the weight force of the projection.

Preferably, the second position of the holding device is a holding and/or supporting position, in which the holding device can hold a run of the line guide device or effect support of the upper run from below, and the first position of the holding device is a retracted position, in which the support element cannot hold a run of the line guide device or cannot effect support of the upper run from below. In its first position, the holding device preferably impairs passage of the deflection arc through the holding apparatus on back-and-forth movement of the line guide device. Passage of the deflection arc through the holding apparatus is preferably impossible on back-and-forth motion of the line guide device, for as long as the holding device is in its second position.

The distance between the holding device and the projection is preferably slightly greater than the height of the line guide device.

The rocker element is preferably configured such that the second leg, preferably with its holding face, rests against the inner face of the line guide device, particularly preferably the underside of the upper run, when the holding device is in its second position. The rocker element is preferably configured such that the first leg, more precisely the locking face of the rotational locking device, rests against a side face of the line guide device, particularly preferably the upper run or the deflection arc, when the holding device is in its second position. More preferably, the rocker element is configured such that the second leg, more precisely the locking face of the rotational locking device, locks the rocker element against rotation displacing the holding device from its second position into the first position by introducing lateral forces into the upper run.

In one embodiment, the projection is located on the outer face of the upper run when the holding device is in its second position. In this embodiment in particular, the switching device and/or the locking device may comprise the projection. The switching face and/or the locking face may then be arranged at least in part against the projection.

The projection may make it possible to arrange the same holding apparatus with line guide devices of different widths. The projection can ensure the functionality of the switching device and/or of the locking device even in the case of narrow line guide devices.

Alternatively, the projection does not rest on the outer face of the upper run if the holding device is in its second position, but rather extends more preferably at a distance parallel thereto. In this embodiment, the projection is preferably not part of the switching device and/or the locking device. The projection may then serve at least first and foremost to increase the weight force, which enables the holding device to be displaced from the second position into the first position and/or provide redundancy, for the switching device and/or the locking device.

The projection resting on the outer face of the line guide device is preferably not a prerequisite for the holding device to be located in its second position. Displacement of the holding device from the first position into the second position and/or vice versa is preferably but at least not solely brought about and/or maintained by an element interacting with the outer face of the line guide device.

Together with the second leg, the projection can receive the upper run in tongs-like manner between the projection and the second leg. Receiving the upper run in this manner for as long as the upper run is arranged in the region of the projection may complicate or prevent rotation of the rocker element and thus displacement of the holding device from the first position into the second position.

The switching device may bring about displacement of the holding device between the first position and the second position through punctiform, linear or areal contact between the switching edge or switching face of the first leg of the rocker element and the line guide device. The switching edge or switching face may here contact an edge of the line guide device between the outer face and a side face and/or the outer face and/or a side face of the line guide device.

The arrangement may comprise a beam, for example a T beam or an I beam with a web and at least one flange, for example lower flange, and one run of the line guide device may be arranged on the flange and in particular run along the flange. For example, one run, in particular the run connectable to the mobile connection point, may slide on a flange, in particular lower flange, of a T beam or an I beam. The beam may be part of a crane.

The holding apparatus may in particular be used to hold a line guide device or energy guide chain which is arranged with an upper run extending above a lower run and held at a distance therefrom, the lower run in particular being the mobile run, i.e., the run connected to the mobile connection point.

The holding apparatus may be fastened to the web of the support. The side guide of the holding apparatus may be formed at least in part by the web or interact therewith.

This use of the web and/or flange of the support which is present in any case reduces the manufacturing effort for the holding apparatus is reduced.

The features of all aspects, i.e., in particular features of the holding apparatus and the arrangement, are initially disclosed and claimed independently for the purposes of the invention but, as is apparent, can also be combined with one another.

All the features of the exemplary embodiment or the respective aspects and embodiments set out further above are mutually independently generally disclosed as features of the invention, in each case taken alone or in combination with one another, also in combination with features other aspects and embodiments.

### BRIEF DESCRIPTION OF THE DRAWINGS

Further details, advantages and features of the invention may, without limiting the general nature of the above description, be inferred from the following part of the description in which an exemplary embodiment is explained in greater detail with reference to the appended schematic drawings in which:

FIG. 1 is a perspective representation of one exemplary embodiment of the arrangement according to the invention and of the holding apparatus according to the invention, with the line guide device approaching the holding apparatus;

FIG. 2 is a view as in FIG. 1, with the holding apparatus shown only in part for clarity's sake;

FIG. 3 is a representation as in FIG. 1, with the line guide device having arrived in the holding apparatus;

FIG. 4 is a view as in FIG. 3, with the holding apparatus shown only in part for clarity's sake;

FIG. 5 is a view as in FIG. 1, with the line guide device held in the holding apparatus;

FIG. 6 is a view as in FIG. 5, with the holding apparatus shown only in part for clarity's sake;

FIGS. 7-9 are a representation of the holding apparatus from three sides;

FIG. 10 is a perspective representation of the holding apparatus from FIGS. 7-9;

FIGS. 11-13A are a representation of the rocker element from three sides;

FIG. 13B is a perspective representation of the rocker element;

FIGS. 14, 15 are perspective representations of the rocker element from different viewing angles;

FIGS. 16-18 are a representation of the insertion device from three sides;

FIGS. 19, 20 are perspective representations of the insertion device from different viewing angles;

FIGS. 21-23 are a representation of the holder from three sides;

FIGS. 24, 25 are perspective representations of the holder from different viewing angles;

FIGS. 26-28 are the line guide device and the rocker element, with the rocker element in various rotation positions about the axis of rotation;

FIG. 29 is a representation similar to FIG. 3, from a slightly different viewing angle and with the line guide device having arrived somewhat further in the holding apparatus; and

FIG. 30 is a schematic depiction of an exemplary embodiment of the arrangement on a crane.

### DETAILED DESCRIPTION

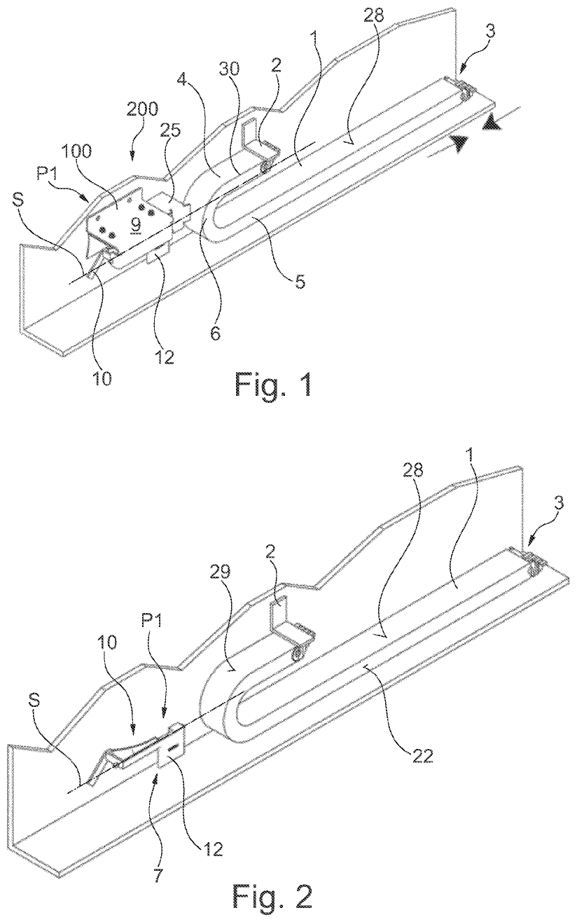

The exemplary embodiment of the holding apparatus according to the invention shown in the figures is designated overall as 100. The holding apparatus 100 serves to hold a line guide device. As FIG. 1 shows, this line guide device extends between two connection points 2, 3 mobile relative to one another and comprises one run 4 connectable to one of the connection points 2 and one run 5 connectable to the other connection point 3 and a deflection arc 6 connecting the runs. In the exemplary embodiment, the line guide device is configured as an energy guide chain 1 and comprises an upper run 4 connected to the stationary connection point 2 and a lower run 5 extending below the upper run and connected to the mobile connection point 3.

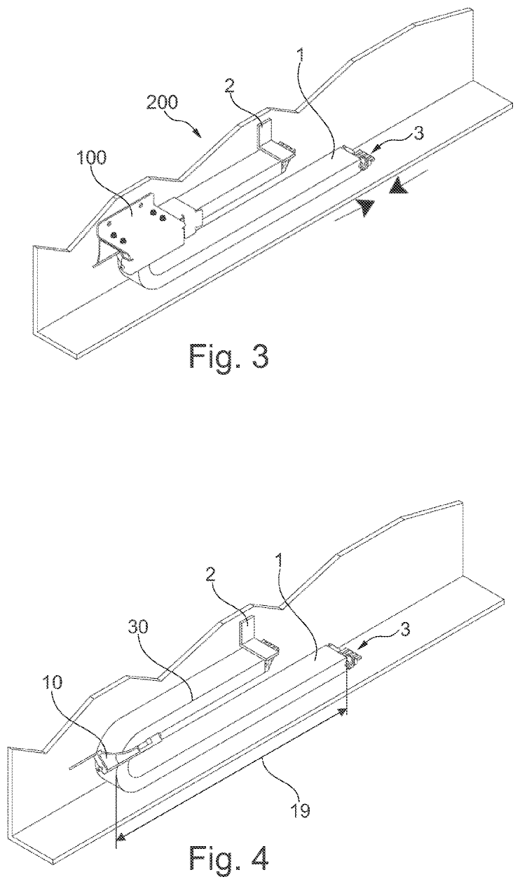

As FIGS. 1 to 15 show, the holding apparatus 100 has a holding device 7, which is displaceable between a first position P1 and a second position P2, and a switching device 8, for bringing about this displacement.

It is clear, in particular from FIGS. 2 and 6, that the second position P2 of the holding device 7 is a holding and supporting position, in which the upper run is supportable from below by the holding device and that the first position P1 of the holding device 7 is a retracted position, in which a run of the line guide device is not holdable by the holding device 7 or the upper run is not supportable from below.

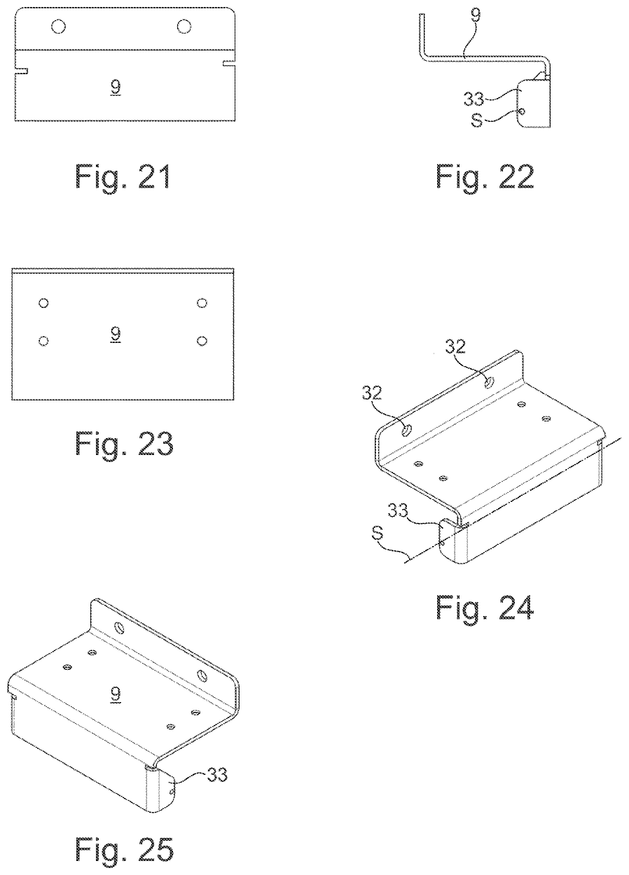

The holding apparatus 100 additionally has a holder 9 for the holding device 7 (see FIG. 10 and FIGS. 21-25).

The holding device 7 and the switching device 8 are arranged on a rocker element 10 mounted rotatably on the holder 9 about an axis of rotation S. The rocker element has a first leg 11 and a second leg 12. The second leg 12 is arranged offset relative to the first leg 11 in the longitudinal direction of the axis of rotation S (see FIGS. 1, 2 and 15).

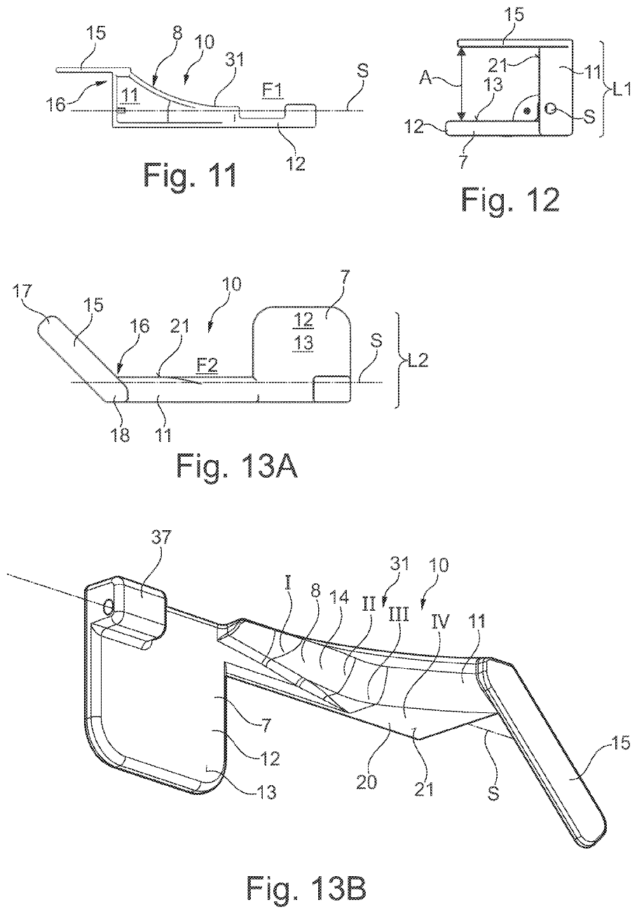

Each leg 11, 12 leaves a space F1, F2 in the region of the axis of rotation S, over which the respective other leg 11, 12 extends (FIGS. 11 and 13). Thus, the first leg 11 leaves a space F1 in the region of the axis of rotation S over which the second leg 12 extends (FIG. 11) and the second leg 12 leaves a space F2 in the region of the axis of rotation S over which the first leg 11 extends (FIG. 13).

The rocker element 10 is mounted to be rotatable by approximately 90° (FIGS. 2, 6 and 26, 28).

The switching device 8 is actuatable by the deflection arc 6 and the holding device 7 is thereby displaceable from its first position P1 into its second position P2.

The rocker element 10 is additionally rotationally lockable by the line guide device with the assistance of a rotational locking device 20.

The rotational locking device 20 has regions which are different from the switching device 8.

The rocker element 10 is configured in one piece and the legs 11, 12 are bent by approximately 90° relative to one another.

As FIG. 13, for example, shows the holding device 7 comprises a flat holding face 13 of the second leg 12 configured as an upper run bearing face.

The line guide device forms an edge 30 in each case between each side face 22 and the outer face 29 of the line guide device.

As FIGS. 4 and 15 show, the first leg 11 comprises a switching face 14 for contacting the line guide device.

The switching face 14 is arranged at the free end 31 of the first leg 11. It is most clearly visible in FIG. 13B and FIG. 15. It extends in curved manner, specifically such that its distance from the axis of rotation increases in the direction pointing along the axis of rotation and away from the holding device and in this way it is ensured that the switching face 14 projects, in the direction corresponding to the direction of movement of the line guide device approaching the holding device (in FIG. 13B therefore from left to right) increasingly into the travel path of the line guide device. FIG. 13B shows contact regions I, II, III between the line guide device and the switching face 14 in the order in which they arise with the line guide device coming from the left in FIG. 13B and a contact region IV between the line guide device and the locking face 21.

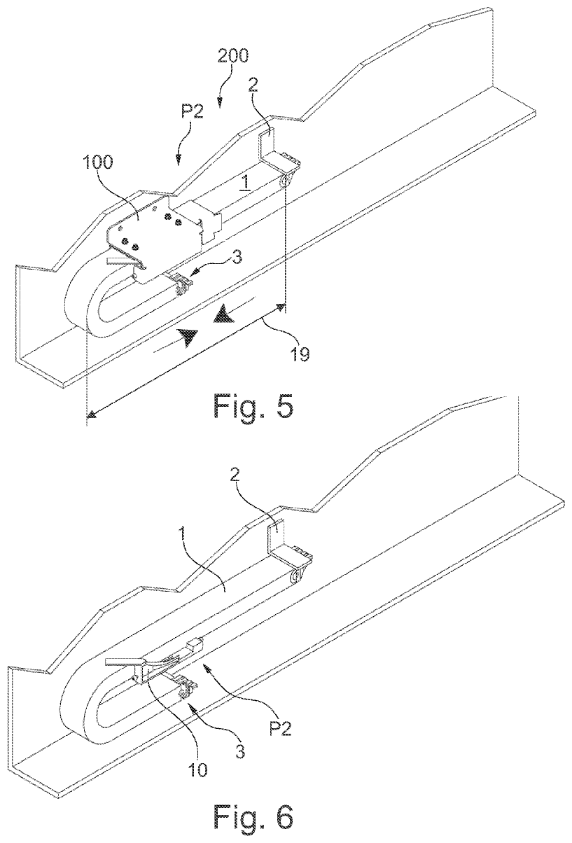

The rotational locking device 20 serves to prevent rotation of the rocker element 10 when the line guide device, shown in FIG. 5, is held by the holding device 7, for as long as the deflection arc 6 is not being passed through.

The rotational locking device 20 comprises a locking face 21 arranged on the first leg 11 for contacting a side face 22 of the line guide device and for introducing locking pressure forces into this side face 22.

As FIG. 13B, for instance, shows the switching face 14 merges into the locking face 21.

The first leg 11 has a side face defined by its free end 31 and forming the locking face 21, which side face forms an angle of approximately 90° with the holding face 13 of the second leg 12 when viewed in the direction of the axis of rotation S (see FIG. 12).

The holding apparatus 100 has a side guide 23 for the line guide device. The side guide 23 interacts with side faces of the line guide device. The side guide comprises a counter-holder 24 for introducing locking pressure reactive forces into a side face 22 of the line guide device (see, for example FIG. 8). The counter-holder 24 is preferably configured such that it may introduce locking pressure reactive forces into a side face of the line guide device which is opposite the side force into which the locking pressure forces are introducible by way of the rotational locking device 20.

In a viewing direction parallel to the axis of rotation S, the second leg 12 forms an “L” shape together with the first leg 11 (see FIG. 12, wherein the view here is directed from the wrong side parallel to the axis of rotation S, such that the “L” is back to front).

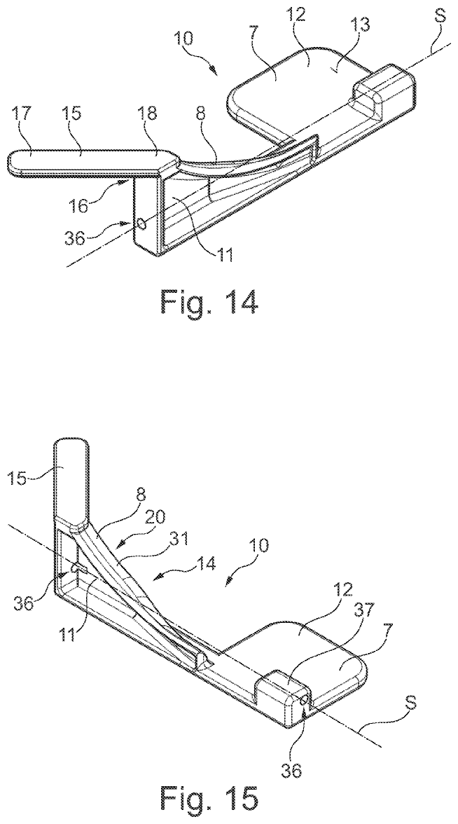

As FIGS. 14 and 15 show, the rocker element 10 comprises a projection 15 arranged on the first leg 11 and bent relative thereto. This projection extends parallel to the second leg 12 at a distance A (see FIG. 12). The projection 15 preferably projects from a region 16 of the first leg 11 from the free end 31 thereof which is furthest away from the second leg 12 in the direction of the axis of rotation S and which is at the greatest distance from the axis of rotation S.

The length L1 of the greatest extent of the first leg 11 in a direction perpendicular to the axis of rotation S corresponds at least substantially to the length L2 of the greatest extent of the second leg 12 in a direction perpendicular to the axis of rotation S (see for example FIGS. 12 and 13).

The length of the projection between the free end 17 thereof and the opposite end 18 thereof corresponds substantially to the length of the extent of the second leg 12 in the direction perpendicular to the axis of rotation S.

In a viewing direction parallel to the axis of rotation, the rocker element 10 forms a C shape, with legs of roughly equal length in this viewing direction which extend parallel to one another. The second leg 12 and the projection 15 here form the legs of this “C” shape and the first leg 11 forms the connecting region of the “C” shape (see FIG. 12, wherein here the view is directed from the wrong side parallel to the axis of rotation S, such that the “C” is back to front).

The projection 15 extends obliquely relative to the axis of rotation S, specifically such that the free end 17 thereof is further from the holding device 7 than the opposite end 18 thereof (see FIG. 13).

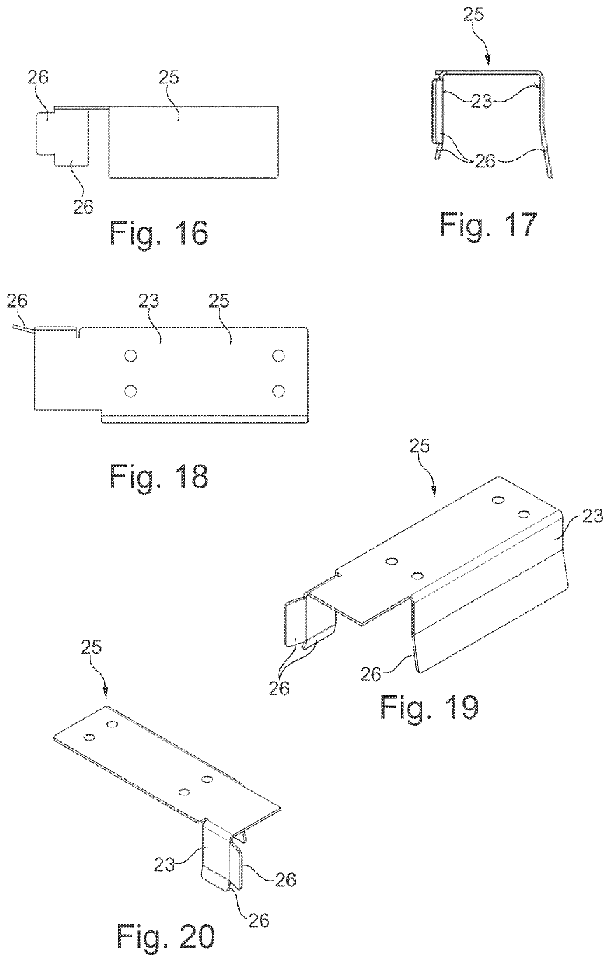

The holding apparatus 100 comprises an insertion device 25. This has a plurality of insertion bevels 26. In the exemplary embodiment, the insertion device 25 also comprises the side guide 23 (see FIGS. 16 to 20).

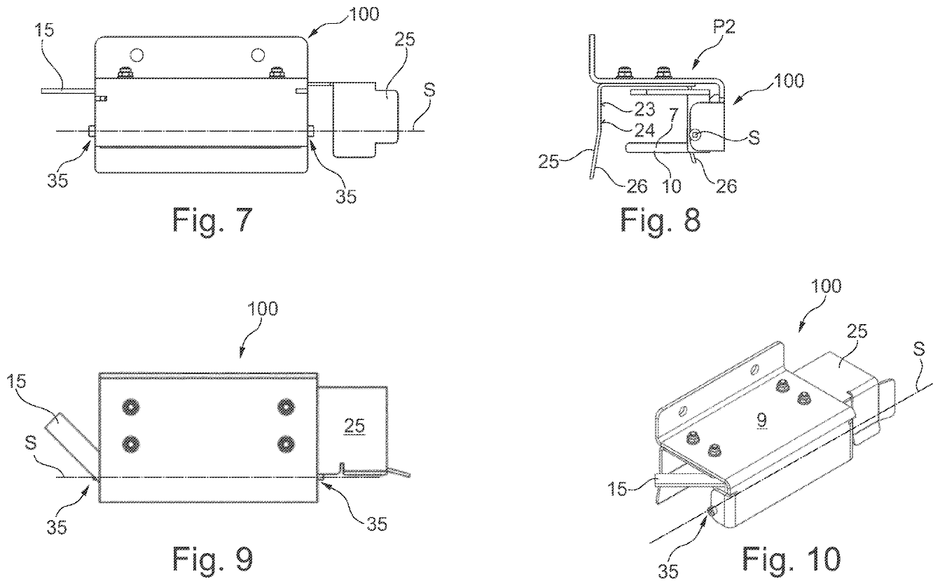

Two pivot bearings 35 are provided which comprise two pivot bearing parts 36 spaced apart on the rocker element 10 in the direction of the axis of rotation S and two pivot bearing parts on the holder 9. One of the pivot bearing parts 36 of the rocker element 10 is arranged on the first leg 11 and the second pivot bearing part 36 of the rocker element 10 on a bearing projection 37, which projects from the second leg 12 (see FIGS. 7, 14 and 15).

In a section plane extending perpendicular to the axis of rotation, the holder 9 forms a “Z”-shaped cross-section with a connecting region and two end regions in each case projecting perpendicularly and in different directions from opposite ends of this connecting region (apparent from FIG. 22, wherein the view here is directed from the wrong side parallel to the axis of rotation S, such that the “Z” is back to front; FIG. 22 moreover shows the “Z” lying down). One of the end regions (shown on the right in FIG. 22) has two protrusions 33, on each of which is arranged a pivot bearing part 36 of the two pivot bearings 35 of the holding apparatus 100, the rocker element 10 being arranged between these protrusions 33. Fastening means in the form of holes 32 for fastening the holder for example to an I beam are provided at the other end region.

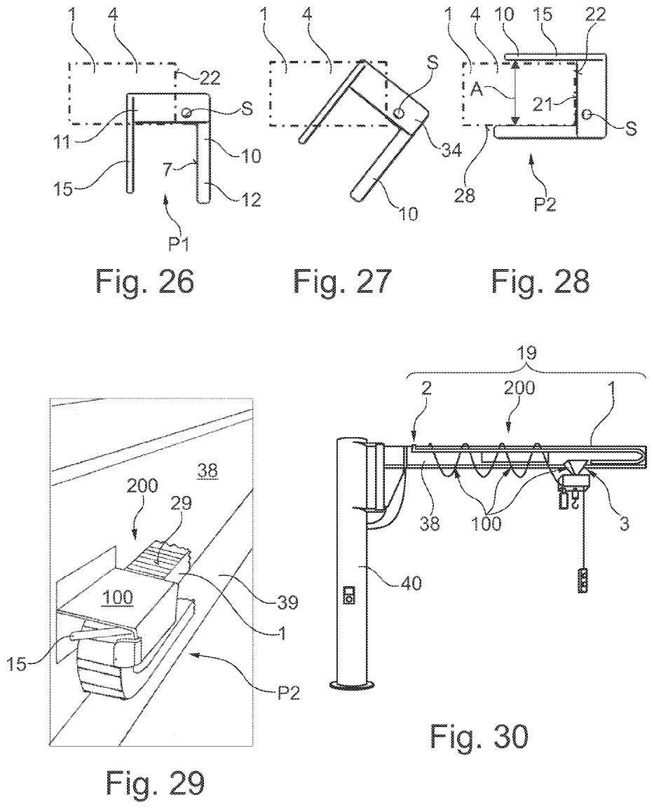

When viewed in the direction of the axis of rotation S, the rocker element 10 has a region 34 (shown by broken lines in FIG. 27) in which the first leg 11 merges into the second leg 12. The axis of rotation S is not arranged in this region 34, but rather merely extends through a leg, specifically the first leg 11 (see FIG. 26).

One exemplary embodiment of the arrangement 200 according to the invention with a plurality of holding apparatus 100 and a line guide device in the form of an energy guide chain 1, is shown in FIGS. 1 to 6, 29 and 30, wherein FIGS. 1 to 6 and 29 show just a portion, or just a holding apparatus 100. The axis of rotation S about which the rocker element 10 is mounted rotatably on the holder 9 is arranged parallel to the longitudinal extent 19 of the line guide device (see FIG. 1).

When the line guide device approaches the holding apparatus 100, corresponding movement of the mobile connection point 3 results in the holding device 7 initially being located in its first position P1 (see FIGS. 1 and 2).

The arrangement 200 is configured such that, when the line guide device approaches the holding apparatus 100, the deflection arc 6 firstly passes the second leg 12 of the rocker element 10 contactlessly (see FIGS. 2 and 4) before reaching the first leg 11 of the rocker element 10, and, through contact therewith, the rocker element 10 effects a rotation displacing the holding device 7 from its first position P1 into the second position P2 (see FIGS. 4 and 6). This rotation causes the second leg 12 to position itself against the inner surface 28 of the line guide device in the region of the upper run 4 and to hold and support this run 4 in this manner (for instance FIGS. 6 and 28).

To maintain this support, the rocker element 10 is here rotationally locked by the locking face 21 of the rotational locking device 20 positioning itself against a side face 22 of the line guide device (see FIG. 28).

So as not to impair passage of the deflection arc 6 though the holding apparatus 100 on movement of the line guide device, in particular of the mobile connection point, in the opposing direction, when the deflection arc 6 approaches this holding apparatus 100 the held upper run 4 firstly moves away from the first leg 11 and thus from the rotational locking device 20, whereby the latter is disabled. The rocker element 10 therefore effects a rotation displacing the holding device 7 from its second position P2 into the first position P1. This takes place before the deflection arc 6 reaches the second leg 12, specifically using the weight force of the second leg 12 and of the projection 15.

The rocker elements 10 of the retaining devices 100 are arranged on just one side of the line guide device.

As FIG. 28 shows, the distance A between the holding device 7 and the projection 15 is slightly greater than the height of the line guide device.

The rocker element 10 is configured such that the second leg 12 rests with its holding face 13 against the inner face 28 of the line guide device, more precisely the underside of the upper run 4, when the holding device is in its second position P2. The rocker element 10 is additionally configured such that the first leg 11, more precisely the locking face 21 of the rotational locking device 20, rests against a side face 22 of the line guide device, more precisely the upper run 4, when the holding device 7 is in its second position P2.

In the exemplary embodiment shown, the lower run slides on the lower flange 39 of an I beam 38, which is part of a crane 40 (FIGS. 29 and 30).

FIG. 29 shows that the projection 15 resting on the outer face 29 of the line guide device is not a prerequisite, in the exemplary embodiment shown, for the holding device 7 to be located in its second position P2.

In the exemplary embodiment shown, the holding apparatus 100 is fastened to the web of the I beam 38 and the web supports the side guide 23 of the holding apparatus 100.

### LIST OF REFERENCE SIGNS

100 Holding apparatus
200 Arrangement
1 Energy guide chain
2 Connection point
3 Connection point
4 Run
5 Run
6 Deflection arc
7 Holding device
8 Switching device
9 Holder
10 Rocker element
11 First leg
12 Second leg
13 Holding face
14 Switching face
15 Projection
16 Region of the first leg
17 Free end of the projection
18 Opposite end of the projection from the free end
19 Longitudinal extent of the line guide device
20 Rotational locking device
21 Locking face
22 Side face of the line guide device
23 Side guide
24 Counter-holder
25 Insertion device
26 Insertion bevels
28 Inner face of the line guide device
29 Outer face of the line guide device
30 Edge of the line guide device
31 Free end of the first leg
32 Holes
33 Protrusions
34 Region
35 Pivot bearing
36 Pivot bearing parts
37 Bearing projection
38 I beam
39 Lower flange
40 Crane
A Distance between projection and second leg
F1 Space
F2 Space
L1 Length
L2 Length
P1 First position
P2 Second position
S Axis of rotation
I-IV Contact regions

What is claimed is:

1-15. (canceled)

16. A holding apparatus for a line guide device, in particular for an energy guide chain, which extends between two connection points mobile relative to one another and comprises one run connectable to one of the connection points and one run connectable to the other connection point and a deflection arc connecting the runs, wherein:
the holding apparatus has at least one holding device, which is displaceable between a first position and a second position, a switching device, which can be used to bring this displacement about; and
a holder for the holding device, wherein the holding device and the switching device are arranged on a rocker element mounted rotatably on the holder about an axis of rotation and having a first leg and a second leg, wherein the second leg is arranged offset relative to the first leg in the longitudinal direction of the axis of rotation.

17. The holding apparatus according to claim 16, wherein the legs are bent relative to one another, by approximately 90°.

18. The holding apparatus according to claim 16, wherein the legs are non-displaceable relative to one another.

19. The holding apparatus according to claim 16, wherein the holding device comprises a flat holding face of the second leg for contacting the line guide device.

20. The holding apparatus according to claim 16, wherein the switching device comprises a switching edge or a switching face, provided on the first leg, for contacting the line guide device.

21. The holding apparatus according to claim 20, wherein the switching edge or switching face extends obliquely to the axis of rotation and/or in curved manner, preferably such that the distance thereof from the axis of rotation increases in the direction pointing along the axis of rotation and away from the holding device.

22. The holding apparatus according to claim 20, wherein the first leg comprises a switching face for contacting the line guide device, wherein the switching face is twisted on itself.

23. The holding apparatus according to claim 16, wherein the rocker element is rotationally lockable using a rotational locking device which differs from the switching device and the rotational locking device comprises a locking face, the locking face being arranged on the first leg, for contacting a side face of the line guide device and for introducing locking pressure forces into this side face.

24. The holding apparatus according to claim 23, wherein the holding apparatus has a side guide for the line guide device, which comprises a counter-holder for introducing locking pressure reactive forces into a side face of the line guide device.

25. The holding apparatus according to claim 16, wherein the rocker element comprises a projection arranged on the first leg and bent relative thereto with a free end and an end opposite the free end, which projection extends at least substantially parallel to the second leg at a distance therefrom.

26. The holding apparatus according to claim 25, wherein the projection projects from a region of the first leg which is furthest away from the second leg in the direction of the axis of rotation and is at the greatest distance from the axis of rotation.

27. The holding apparatus according to 25, wherein the free end of the projection is further away from the holding device than its opposite end.

28. The holding apparatus according to claim 16, wherein the holding apparatus comprises an insertion device with at least one insertion bevel.

29. An arrangement with at least one holding apparatus according to claim 16 and a line guide device, in particular an energy guide chain, which extends between two connection points mobile relative to one another and comprises one run connectable to one of the connection points and one run connectable to the other connection point and a deflection arc connecting the runs, and a longitudinal extent, an outer face, an inner face and two opposing side faces, wherein the axis of rotation is arranged parallel to the longitudinal extent of the line guide device.

30. The arrangement according to claim 29, wherein the rocker element is rotationally lockable and the arrangement is configured such that, when the line guide device approaches the holding apparatus, the holding device is located in its first position and the deflection arc firstly passes the second leg of the rocker element before reaching the first leg of the rocker element and, through contact therewith, the rocker element effects a rotation displacing the holding device from its first position into the second position, such that the second leg positions itself against the inner face of the line guide device in the region of one run and holds this run in this manner, and the rocker element is rotationally locked and, when the deflection arc approaches this holding apparatus, the held run initially moves away from the first leg, the rotational locking hereby being disabled, and the rocker element effects a rotation displacing the holding device from its second position into the first position before the deflection arc reaches the second leg.
